(19) United States
(12) Patent Application Publication
(10) Pub. No.: US 2009/0023124 A1
(43) Pub. Date: Jan. 22, 2009

(54) Software Application System as an Efficient Client or Case Management Tool

(75) Inventors: Dwayne E. Towell, Abilene, TX (US); Gideon P. Botha, Abilene, TX (US); Robert J. Reese, Lexington, KY (US)

Correspondence Address: MEGAN LYMAN, 1816 SILVER MIST CT., RALEIGH, NC, 27613, US

(73) Assignee: PHAROS RESOURCES, LLC, Horseshoe Bay, TX (US)

(21) Appl. No.: 12/173,523

(22) Filed: Jul. 15, 2008

Related U.S. Application Data
(60) Provisional application No. 60/950,746, filed on Jul. 19, 2007.

(51) Int. Cl. G09B 5/00

(52) U.S. Cl. 434/322

(57) ABSTRACT

A web application that facilitates the interaction between an educational institution and its members for the purpose of assisting a student in need is described. The application provides an accessible and user-friendly system for members of an educational institution to provide and gather information. The application may perform various functions that allow rapid and efficient transmission of information regarding a student in need so that those needs may be addressed.

This nonprovisional utility application claims the benefit of U.S. Provisional Application Ser. No. 60/950,746 filed Jul. 19, 2007 under 35 U.S.C. § 119(e).

### BACKGROUND

The present invention relates generally to a software system that works as a client and or case management tool designed to facilitate the assistance of a student at an educational institution. More particularly, the present invention is a system that provides means for members of an educational institution to efficiently interact, transmit, and gather information to proactively identify and assist a student in need.

Retention rate has been defined by the federal government and is required to be reported on an annual basis by educational institutions. As defined, “program retention” tracks the full-time student in a degree program over time to determine whether the student has completed the program. Retention rate is an important statistic for educational institutions, from both a financial and emotional perspective. Retention rates are viewed by prospective students and their parents and a low retention rate will likely lead to the educational institution as being viewed as less desirable, and may even affect the institution's ranking, leading to a decrease in the applicant pool. Moreover, when a student discontinues his or her studies, the educational institution suffers a large financial loss in terms of future tuition payments as well as potential financial contributions as an alumnus. Other reasons educational institutions are so interested in improving retention rates include the prevention of loss for the student as a member of society in development of critical thinking skills, preparation of the student for the working environment, and increasing the student's tolerance of individual differences. It is also important to note that as a student progresses in his or her studies, the community within the educational institution becomes invested in each student, hoping to nurture the student not only academically, but personally, as they accomplish their educational goals. When a student discontinues his or her studies, this investment is lost.

Once a student is in struggle, unless identified and resolved, the student may suffer poor performance in his or her studies or a lack of interest in progressing at the institution. If unresolved, the student may terminate his or her studies at that institution. Where the student's needs can be identified and assisted at the onset of such an issue, before those needs lead to a decrease in performance, the likelihood that the student will terminate his or her studies decreases significantly. This results in an increased retention rate for the educational institution and a correlative increase in desirability of the institution by prospective students. It also results in a happier student and academic community as a whole. Moreover, as distinguished from present retention systems, a system that addresses non-academic, as well as academic needs of the student is necessary to attain the highest retention rate achievable by the educational institution. See Levitz, Highlights from 4 Institutions Getting Results, Spring 1998, Strategies, pg. 157. It also results in a happier student and academic community.

The dilemma presented is that many students in the midst of struggle are unaware of the resources available to them. “Institutions need to take these initiatives, rather than expecting the student to take them, because many students are not in a position to commit themselves fully to or even understand the many and right resources of the institution and their accompanying benefits.” Levitz & Noel, 1999, pg. 127.

However, any system to monitor student needs and assist those needs must be rapid, efficient and user-friendly, allowing those needs to be identified and addressed in the timeliest of manners by as many people as possible. To effectuate identification and assistance a system that is rapid, efficient, and easy to use by the institution is imperative. While some programs attempt to increase student retention by identifying students in need, no system takes into account needs that exist beyond the academic realm and makes that system accessible to all members of the educational institution. Thus, it is desirable to establish a system that is tangible to all members of an educational institution and efficient in allowing the institution to proactively identify a student in need, transmit and gather information regarding the student, and provide assistance to the student at the earliest stage possible at any stage in the student's educational experience.

### SUMMARY

An embodiment of the present invention is a software system that works as a client and or case management tool to facilitate the assistance of a student at an educational institution. In this embodiment, the present invention provides means for members of the educational institution to efficiently interact, transmit, and gather information to proactively identify and assist a student in need.

In one embodiment of the present invention, the member of the educational institution proactively identifies a student with needs such as, but not limited to, academic, career choice, social, emotional, spiritual, or physical.

In another embodiment of the present invention, the software system is a Web application that allows a member of the educational institution to easily access a view to input or request information regarding a student in need. In this embodiment, such information may be sent by the member at the institution and will be relayed to an appropriate person within the institution.

In still another embodiment of the present invention, the software system is a Web application that allows a member of the educational institution to receive and assess information in a centralized location regarding the student in need.

In yet another embodiment of the present invention, the present invention allows a member of the educational institution to access various metrics regarding counselor efficacy, retention of students using the present invention versus those not using the system, frequency of specific issues, and resolution frequency. Such access to metrics allows the process of addressing student needs to evolve to be more efficient as it is used at the educational institution. Moreover, such metrics provide the educational institution with real-time statistics of retention rate change as a direct result of the process of addressing student needs.

It is therefore an aspect of the present invention to provide means for members of an educational institution to alert the educational institution of a student's needs through an efficient and user-friendly software system.

It is another aspect of the present invention to provide support for members of the educational institution who may identify a student in need.

It is still another aspect of the present invention to provide a means for members of an educational institution to gather information on a student in need in order to address those needs.

It is an aspect of the present invention to allow for immediate notification of student needs, and gathering of student information.

It is still another aspect of the present invention to provide means to connect members of an educational institution for the assistance of a student in need.

It is another aspect of the present invention to provide a central location for information gathered regarding a student's needs so that an appropriate person may assist the student.

It is yet another aspect of the present invention to retain information about the student and the issue within the system for future use, should the student have future needs.

It is yet another aspect of the present invention to make accessible to the educational institution metrics regarding the system, including: efficacy of counselors, frequency of specific issues, frequency of resolution, and retention rate increases.

These aspects and other embodiments will be come apparent by reference to the drawings and the descriptions that follow.

### DESCRIPTION OF THE DRAWINGS

FIG. 1 illustrates a block diagram of the general scheme of an application designed for use with a client or case management file.

FIG. 2 illustrates a system of views used in the system where a referral of the student in need is made by a member of the educational institution, such as faculty, staff, or a student/peer according to an embodiment of the present invention.

FIG. 3 illustrates an exemplary referral form to be used by persons within the educational institution to identify student needs according to an embodiment of the present invention.

FIG. 4 illustrates the process of an administrator logging into the application.

FIG. 5 illustrates the views accessed by the SOS coordinator in choosing either to accept or reject the referral, where accepted the student is assigned a counselor according to an embodiment of the present invention.

FIG. 6 illustrates a flow diagram of an exemplary counselor contact system wherein the student is contacted via email according to an embodiment of the present invention.

FIG. 7 illustrates a flow diagram of an exemplary process of the initiation of an audit sent to the student's instructors at the institution by the counselor according to an embodiment of the present invention.

FIG. 8 illustrates a flow diagram of an exemplary process for a faculty response to the audit sent by the counselor according to an embodiment of the present invention.

FIG. 9 illustrates a flow diagram of an exemplary process of sending a progress report on the student by the counselor to a member of the Circle of Care according to an embodiment of the present invention.

FIG. 10 illustrates a flow diagram of an exemplary process of a faculty receiving the progress report according to an embodiment of the present invention.

FIG. 11 illustrates a flow diagram of an exemplary process for making record note or contact made to the student's file while part of the system according to an embodiment of the present invention.

FIG. 12 illustrates a flow diagram of an exemplary process for sending an e-mail to a Circle of Care member by the counselor according to an embodiment of the present invention.

FIG. 13 illustrates a flow diagram of an exemplary process for a change status used by the student's counselor according to an embodiment of the present invention.

FIG. 14 illustrates a flow diagram of an exemplary process for changing counselors for use by the counselor according to an embodiment of the present invention.

FIG. 15 illustrates an exemplary process of a nightly update according to an embodiment of the present invention.

FIG. 16 illustrates a flow diagram of an exemplary close case process at resolution of the student's needs according to an embodiment of the present invention.

FIG. 17 illustrates a flow diagram of an exemplary process used by a member of the educational institution to access various metrics produced by the system of addressing student needs according to an embodiment of the present invention.

FIG. 18 illustrates a flow diagram of the web application system according to an embodiment of the invention.

### DESCRIPTION

Objectives and various embodiments of the present invention are described in the detailed discussion that follows.

### Definitions

“Audit” is a means by which a counselor asks a student's instructor for information regarding the student's class attendance, performance, or any other behavior that the instructor would deem pertinent.

“Circle of Care” refers to persons who have referred the student to the system or whom have been contacted to give information about the student and have indicated that they are interested in monitoring the student's progress.

A “counselor” is someone who is either licensed in the field of counseling or is seeking to be licensed and is supervised by a licensed professional in the field of counseling.

“SOS” refers to the “Save Our Students” process of gathering, receiving, assessing, and addressing the needs of a student.

### Overview

In an embodiment of the present invention, a system that provides means for members of the educational institution to efficiently interact, transmit, and gather information to proactively identify and assist a student in need. In this embodiment of the present invention, the software facilitates the educational institution's implementation of the “Save Our Students” (“SOS”) process of gathering, receiving, assessing, and addressing the needs of a student. Furthermore, in this embodiment of the present invention members of the educational institution such as faculty, staff, and other students interact with the educational institution via a network interface to identify a student in need to the educational institution. Persons making such a referral become part of the student's “Circle of Care” network.

In another embodiment of the present invention, a system that provides means for members of the educational institution to efficiently interact, transmit, and gather information to proactively identify and assist a student in need comprises the student being identified and brought into the “Save Our Students” (SOS) system. In this embodiment, the student is identified by a referral form filled out and sent by the web application to the SOS system coordinator. In one embodiment the referral is accepted by the coordinator into the system software, which creates a file for the student, and a counselor is assigned to the student.

In yet another embodiment of the present invention, a system that provides means for members of the educational institution to efficiently interact, transmit, and gather information to proactively identify and assist a student in need where a counselor initiates contact by using the web application with the student for the purposes of assessing the students needs. In this embodiment, the software contains template e-mails that may be personalized and sent to the student by the counselor. Where contact is accomplished the counselor may indicate as such via the web application, which will be recorded in the student's SOS system file.

In still another embodiment of the present invention, a system that provides means for members of the educational institution to efficiently interact, transmit, and gather information to proactively identify and assist a student in need comprising the counselor utilizing the web application to initiate an audit, which seeks information about the student from the student's instructors. In this embodiment, the identification of the student's present instructors is accomplished, as well as means for efficiently sending a request to each instructor via e-mail.

In yet another embodiment of the present invention, a system that provides means for members of the educational institution to efficiently interact, transmit, and gather information to proactively identify and assist a student in need comprising means for a counselor to access the student's file to change his or her status within the system or to assign the student to an alternative counselor.

In a further embodiment of the present invention, a system that provides means for members of the educational institution to efficiently interact, transmit, and gather information to proactively identify and assist a student in need comprising the counselor closing the student's SOS system file through the use of the present invention where the student's needs have been addressed. In this embodiment, closing the file does not serve to delete the entire file from the software, but will store relevant information, such as the counselor's case notes, for potential future referrals of that student to the SOS system at another time.

In yet another embodiment of the present invention, a system that provides means for members of the educational institution to efficiently interact, transmit, and gather information to proactively identify and assist a student in need comprising an authorized member of the educational institution using the present invention to access various metrics of system addressing student needs. In this embodiment such metrics include, but are not limited too: efficacy of specific counselors, frequency of specific issues being brought to the system, resolution frequency, affect of resolution on retention rates, affect of being in the system on retention rates, and the direct impact of the present invention on retention rates at the educational institution as a whole.

### DETAILED DESCRIPTION

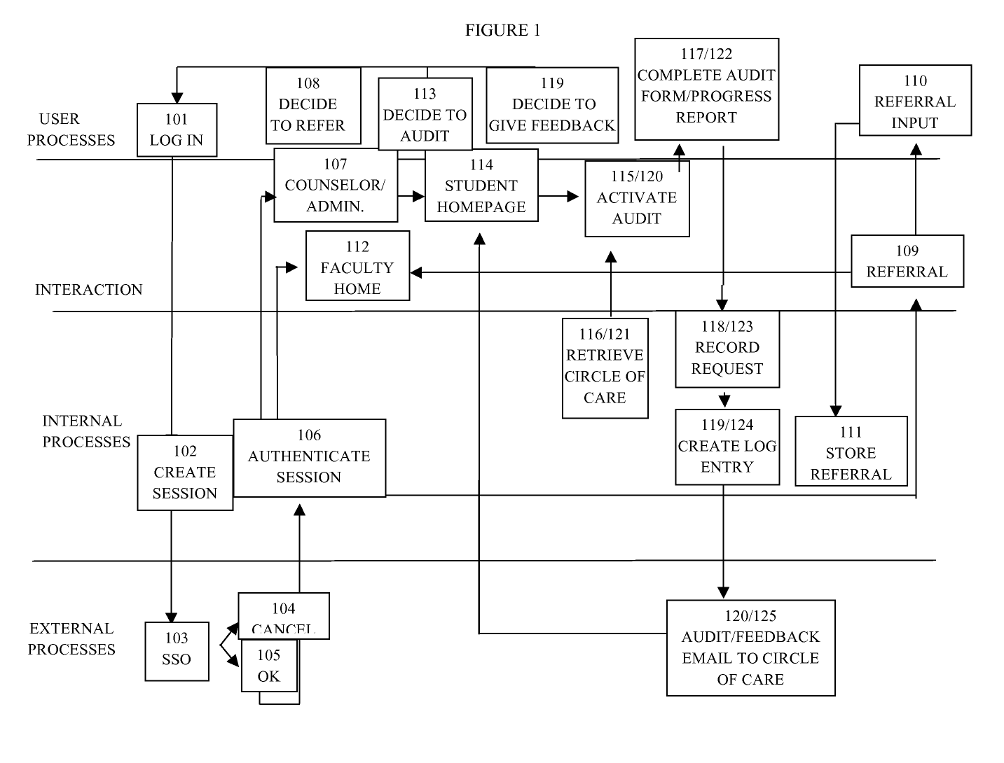

FIG. 1 illustrates the general scheme of the system, in one embodiment. Where a member of the educational institution either decides to refer a student to the SOS process 108, audit the student 113, or to give feedback 119, the member must first log into the software system 101. When the member logs into the system 101 a session is created 102. A Single Sign On (“SSO”) session 103 is created. If the information submitted by the member is verified, the session is authenticated 106. From there the member is directed to his or her designated page which could be a counselor/administrator page 107, a faculty page 112 or direct the member to the referral form 109. The member, if accessing the referral form 109, may input information on a student in need 110, which will then be stored into the system 111, and direct the member to his or her appropriate page 112. Alternatively, where the member is a counselor or administrator, he or she may activate the audit process 115, and complete an audit form 117 after the student's Circle of Care is accessed 116. When completed, a record request will be made 118, a log entry will be made 119, and the counselor may provide feedback to the student's Circle of Care 120. After such feedback is sent, the counselor or administrator is returned to the student's system page 114. In another embodiment where the member is a counselor or administrator, he or she may chose to send a progress report to the student's Circle of Care 120. The Circle of Care will be identified 121 through the system. Once the form is completed 122, a record request is made 123, followed by a log entry 124, just as in the embodiment for completing an audit form. Again, the counselor or administrator will be returned to the student's system page 114.

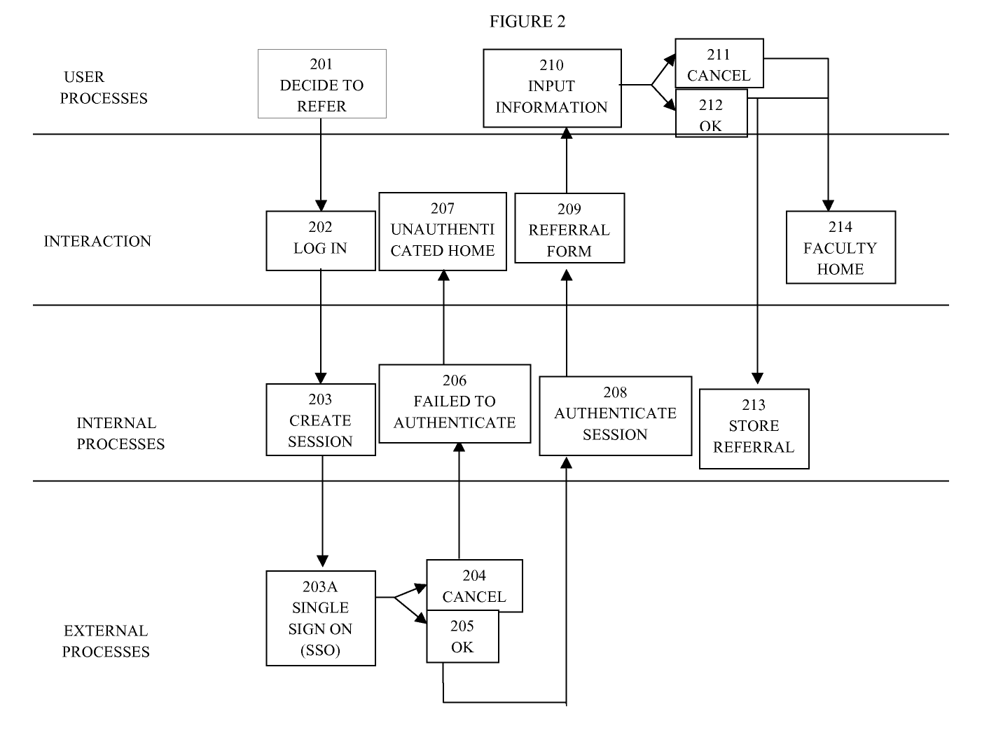

By way of illustration and not as a limitation, the software system facilitates the relationship between the institution and the student in need at the initial contact stage wherein the student is referred to the SOS process by a member of the educational institution through a network interface [FIG. 2]. In one embodiment using a network interface, as illustrated in FIG. 2, the person referring the student, who is also a member of the educational institution, decides to refer the student 201, logs into the institution's network 202, and creates a session 203. After providing the username and password, the educational institution member's information is verified through an external system in the educational institution's network 203a. If the member can be authenticated 205, the software will authenticate the session 208 and open the referral page 209. If the member cannot be authenticated 204, then he or she is returned to an unauthenticated home page 207. Alternatively, the member may cancel the sign on session 204. Once the referral page has loaded 209, the member will input information regarding the student and the perceived need 210. The member may then submit the form 212, where the information will be stored into the system 213, and the member will be returned to his or her home page 214. Alternatively, the member may cancel the process at the referral form stage 211 in which case the member will be returned to his or her home page 214. Other systems of providing an interface for use by a member of an institution to alert the institution of a student in need may be established without departing from the scope of the present invention.

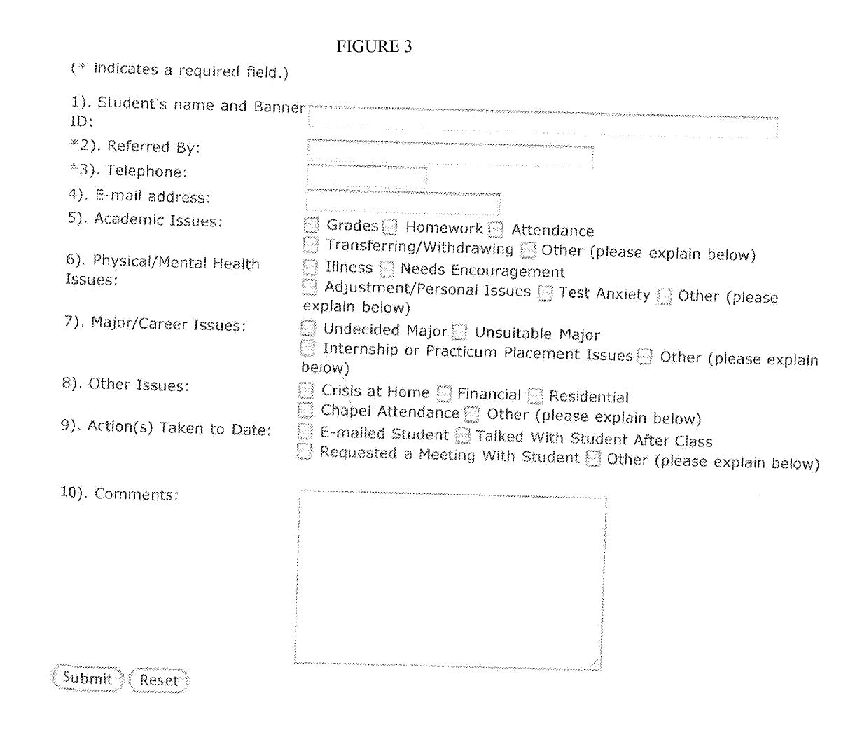

An exemplary referral form is provided in FIG. 3. Here the student and the type of need the student is experiencing are identified. Some types of needs that may be identified include, but are not limited to; (1) academic issues, such as: grades, homework, attendance, transferring/withdrawing, (2) physical/mental health issues: illness, need of encouragement, adjustment/personal issues, test anxiety, (3) major/career issues: undecided major, unsuitable major, internship or practicum placement issues, (4) other issues: crisis at home, financial, residential, chapel attendance, as well as allowing the referring person to identify any other issues the student may be experiencing. The referring member may also include whether they have contacted the student about the issue before making the referral. As those skilled in the art will appreciate, other such forms may sufficiently indicate the student needs to the institution without departing from the scope of the present invention.

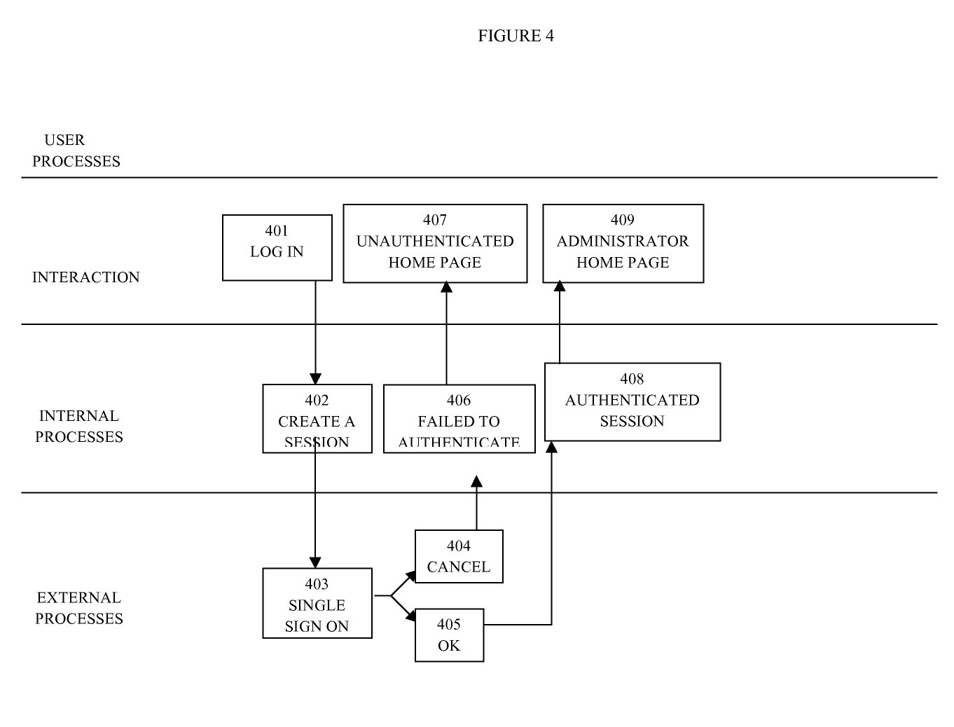

FIG. 4 illustrates the process of administrator log-in. An administrator is a person who is allowed to view the software pages within the system to provide assistance to the student. In order for the administrator of the program to view these software pages, he or she will need to log into the system 401. The software will create a session for the user 402 by using the SSO process 403. If he or she cancels at this point 404 the process will end. If he or she decides to continue 405, his or her information (username and password) will be verified. Once the information has been validated, the software will authenticate the session 408 and open the administrator's home page 409. If the administrator's information is not validated, the session will not be authenticated 406 and the administrator will be taken to an unauthenticated home page 407.

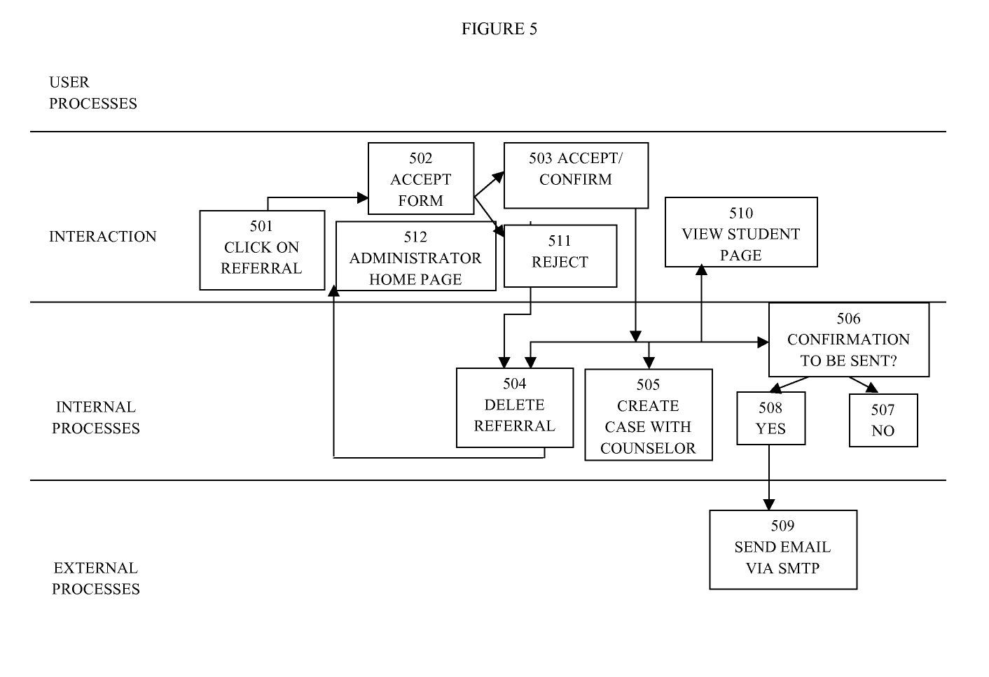

FIG. 5 illustrates the acceptance or rejection of the referral to the SOS process, once a referral is stored in the educational institution's system, according to one embodiment of the present invention. During this process, the administrator of the counseling system will begin by logging into the system as documented in FIG. 4. A new referral link will be displayed, which he or she will click on to view the information regarding the student being referred 501. The administrator will accept or reject the referral 502. If rejected 511, the referral is deleted from the system 504, and the administrator is returned to his or her home page 512. If accepted by the administrator 503, the software will delete the referral 504, and create a case with the counselor 505. The software also prompts the administrator to decide whether or not to send a confirmation e-mail to the person referring the student 506. If a confirmation e-mail will be sent 508, an e-mail is sent via SMTP 509. If a confirmation e-mail will not be sent 507, then the process is complete. After the internal software processes are complete, the administrator will then be taken to the student's page to view his or her information 510.

In one embodiment, when the student is accepted into the system, a file in the system software is created for the student. The file created contains the student's name, the student's identification number, contact information, the student's parent information, if applicable, and the course of study. In one embodiment such information is automatically gathered from other software already in use by the educational institution for the purposes of storing such information. As will be apparent to those skilled in the art, other systems of accepting a student into the system and creating a student file may be established without departing from the scope of the present invention.

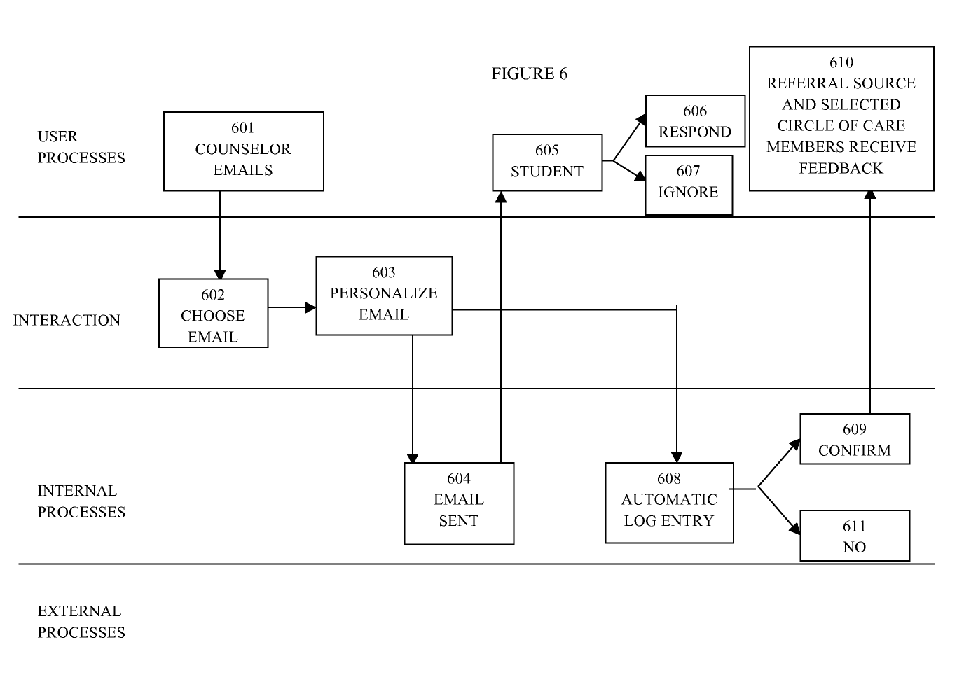

In an embodiment of the present invention, the counselor will then initiate contact with the student through the system using e-mail, FIG. 6. In this embodiment the counselor opens his or her e-mail 601, then chooses an e-mail template 602, and personalizes the e-mail 603. In this embodiment, templates provided by the system cover a variety of general transmissions that are used to initiate contact based on the perceived student need. After the email is personalized 603, it is sent to the student 604. By sending the e-mail, the software makes an automatic log entry 608 into the student's system file. At this point the counselor will determine whether to send feedback to the referral source and to selected Circle of Care members indicating that the counselor has attempted to contact the student. Feedback transmission may either be confirmed 609, in which case the referral source and selected Circle of Care members will receive feedback 610, or not confirmed 611 in which case no feedback is sent. Once the student receives the e-mail 605, he or she may choose to respond 606 or ignore 607 the counselor's e-mail. As those skilled in the art will appreciate, other software systems accomplishing contact with the student may be established without departing from the scope of the present invention.

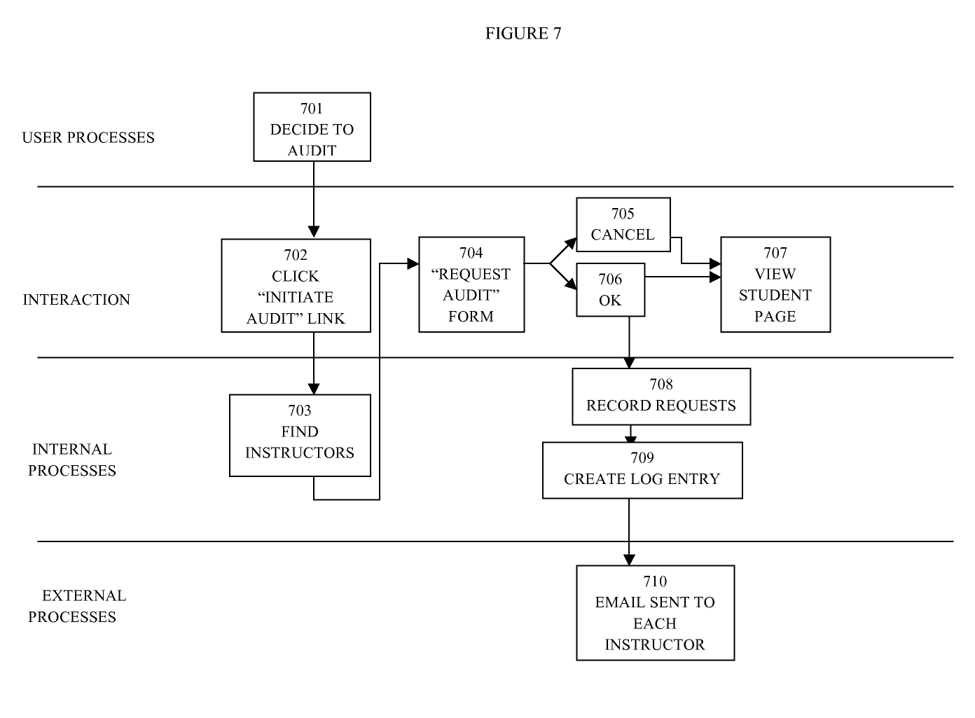

In an embodiment of the present invention, where appropriate, the counselor may use the system to initiate an audit as illustrated in FIG. 7. An audit comprises the system drafting and transmitting an electronic message to the student's instructors which directs the instructor to a page that asks for feedback on the student's performance, attendance and behavior in their courses. In this embodiment, when the counselor decides to audit the student 701, the counselor logs into the system and clicks on the “initiate audit” link 702. This allows the system to check its database to identify the student's current instructors 703. Once the instructors are identified, a “request audit form” will appear 704. The counselor may decide to continue initiating the audit by clicking okay 706, or cancel the request 705, wherein the counselor will be returned to the student's system page 707. If the counselor decides to continue to initiate the audit and clicks okay 706, then system will simultaneously record the request 708, send the e-mails to the appropriate instructors 710, create a log entry in the student's SOS system file 709, and return the counselor to the student's page 707. As those skilled in the art will appreciate, other systems that facilitate the retrieval of information and transmission of requests may be established without departing from the scope of the present invention.

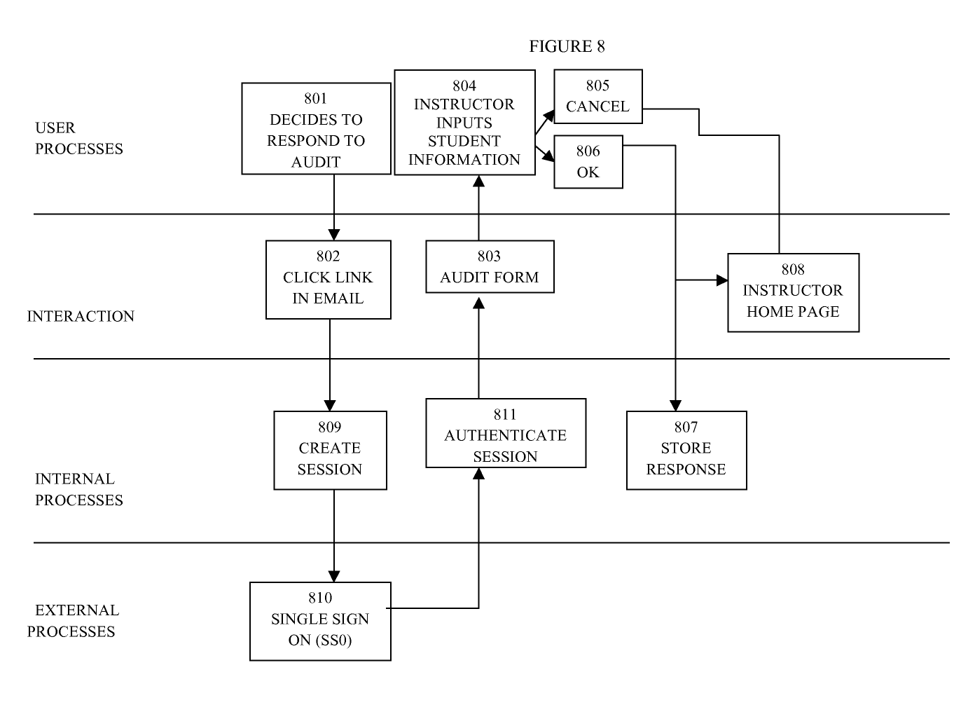

In one embodiment the student's instructors may respond to the audit using the present invention. Where the instructor responds to the request using the system via a network interface, as illustrated in FIG. 8, the instructor first decides to respond 801. On deciding to respond, the instructor clicks on a link within the e-mail sent from the counselor 802, which creates a session in the system 809 and will prompt the instructor for his or her username and password 810. The external system will verify the information and authenticate a session 811. The audit form will appear on the screen 803 at which time the instructor inputs pertinent student information 804. The form also gives the instructor the option to be included in receiving information on the student as they move through the system. If the instructor affirmatively indicates as such, he or she will be added to the student's Circle of Care 804. If the instructor would like to cancel out of the process 805, the system will take them back to their instructor homepage 808. If the instructor fills out the audit form 806, the system will record his or her response into the system 807, and take him or her back to his or her instructor homepage 808. Audit information is received instantaneously by the counselor from the instructor through the system. This gives the counselor the ability to gather and assess information regarding the student's need at an extremely rapid pace.

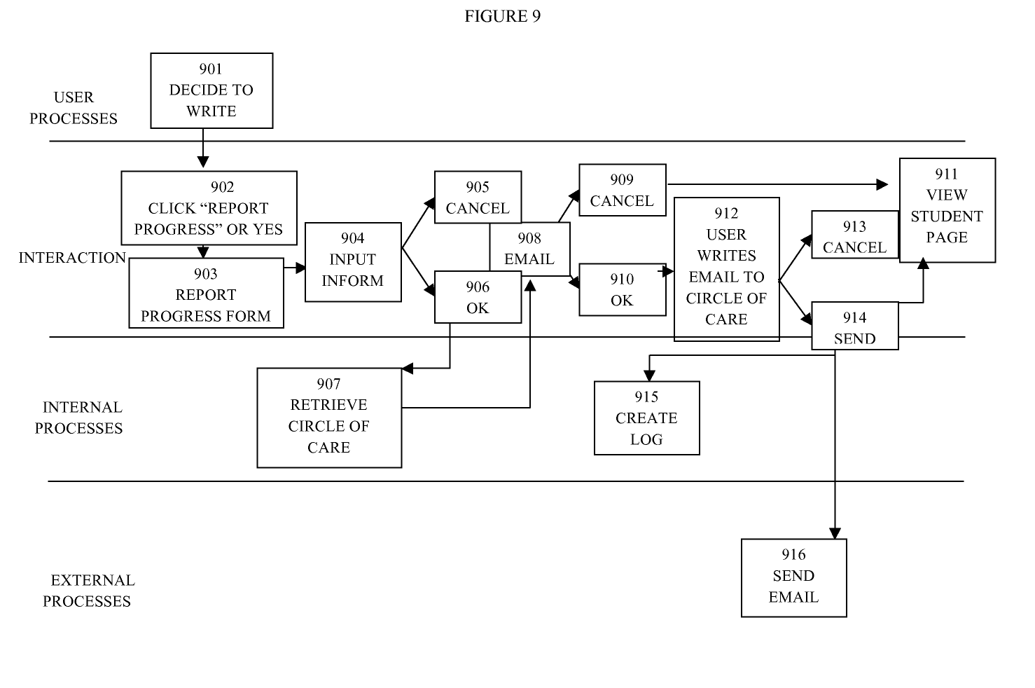

FIG. 9 illustrates the process of sending a progress report in one embodiment of the present invention. When appropriate, progress reports may be sent using the software system by the counselor to members of the student's Circle of Care. In this embodiment of the present invention, when the counselor decides to send such a progress report 901, the counselor using the network interface, may click on a “report progress” link within the system 902, this will allow the counselor access to the report progress form 903. The counselor will then input information into the form 904, at which point the counselor may either cancel 905 or continue 906 submitting the form. If the counselor continues with the progress report, the system will retrieve the Circle of Care members' information 907, and an e-mail form 908 will appear for the counselor to fill out. Again, at this point the counselor may either cancel the process 909 in which case he or she will be returned to the student's system page 911. If the counselor continues with the progress report 910 an e-mail is drafted to the Circle of Care members indicating that the student's progress report may be viewed 912. This drafted e-mail may either be canceled 913, or sent 914. In either case, the counselor is returned to the student's system page 911. Where an e-mail is sent through the external network 916, a log entry in the student's system file is created 915. Other systems facilitating the transmission of information regarding the progress of the student within the system may be established without departing from the scope of the present invention.

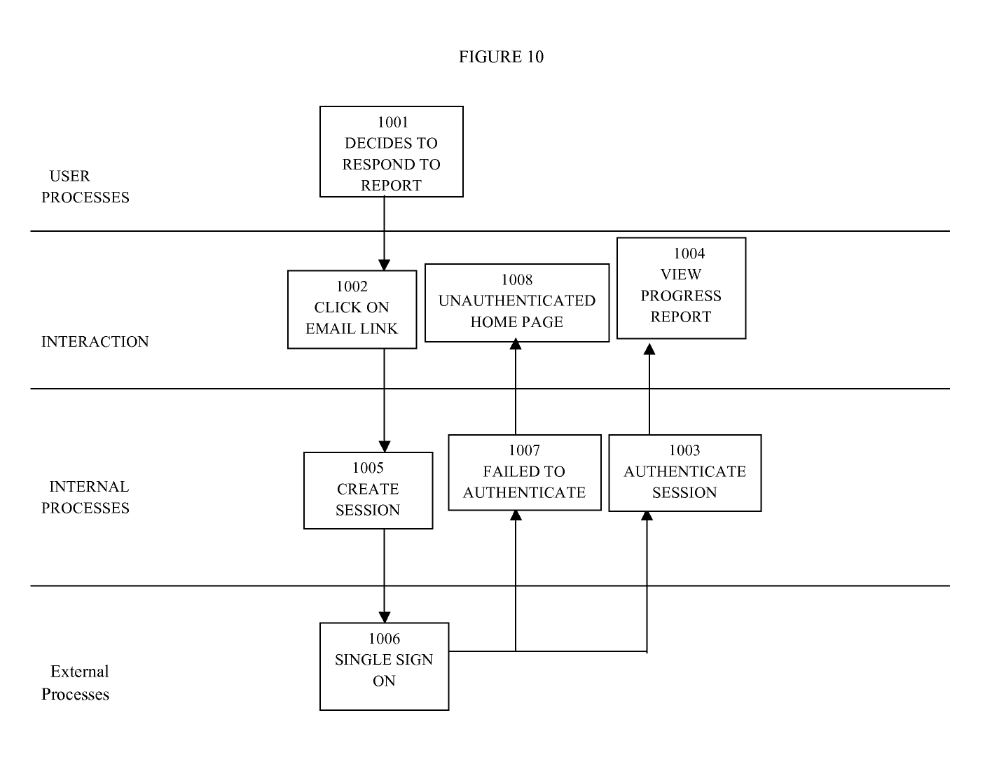

Upon receiving a progress report, a faculty or staff or student at the institution may use the present invention to respond in various ways as illustrated by FIG. 10. By way of illustration and not of limitation, where the individual decides view the report 1001, the individual clicks on the e-mail link, 1002. The system creates a session 1005 for the user and asks them for their login information 1006. The system verifies their identifying information and authenticates the session 1003 in the system. If the session cannot be authenticated 1007, the user will be returned to an unauthenticated homepage 1008. Once authenticated 1003, the system will open the report on the screen for the user to review 1004.

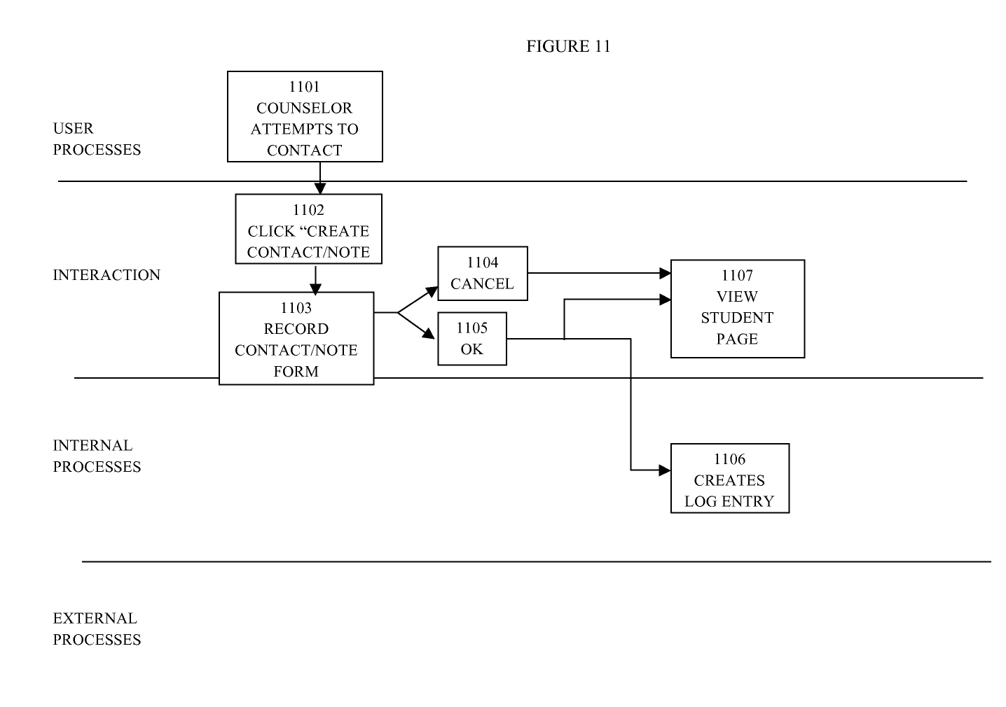

In one embodiment the counselor may use the present invention to create a record note or contact in the student's system file as illustrated by FIG. 11. In this embodiment, when the counselor attempts to contact the student 1101, the counselor may enter the network system and click on a link to “create contact/note” 1002. The software will display the record contact/note form 1103 where the counselor may write in the time spent recording the contact/note, specify the care area, and describe the contact or information he or she wishes to log. The counselor may either cancel 1104 the actions, at which time he or she will be returned to the student's system page 1107, or may click okay 1105, at which point the software will simultaneously create a log entry 1006 and return the counselor to the student's system page 1107.

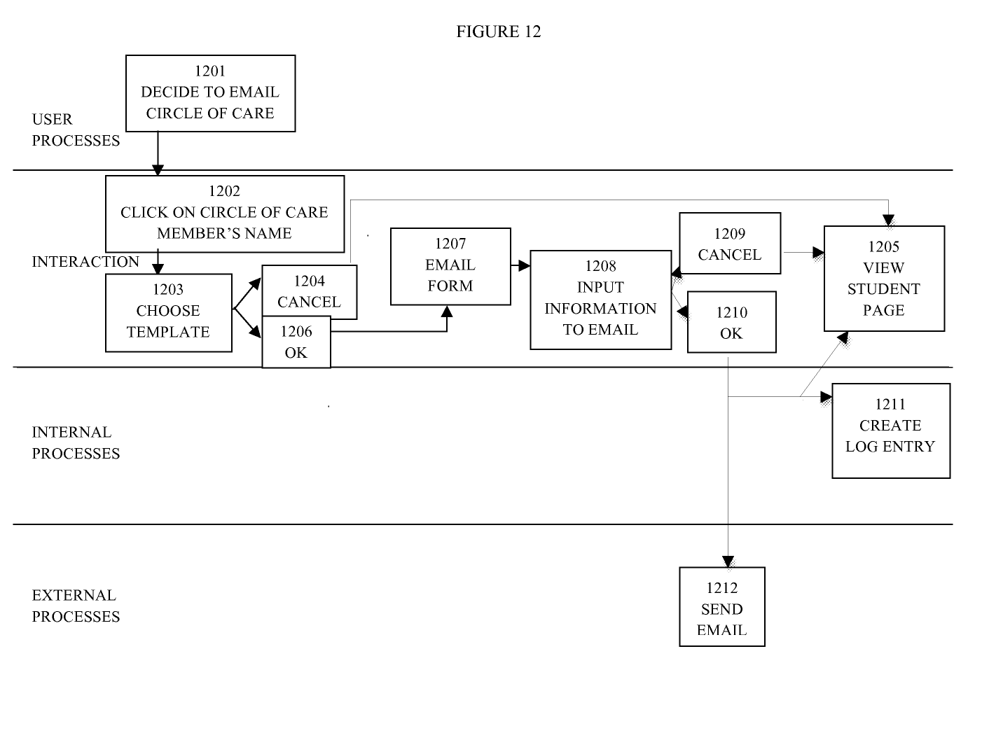

In another embodiment of the present invention the system may be used where a counselor wishes to send an electronic mail to the Circle of Care Members. This embodiment is illustrated in FIG. 12. In this embodiment the counselor makes the decision to e-mail a Circle of Care member 1201, and clicks on the Circle of Care member's name contained in the student's system page 1202. The counselor then chooses a template form 1203 that will address the purpose of the email. If the counselor cancels the transaction 1204 at this time he or she will be directed to the student's system page 1205. If the counselor continues 1206, the e-mail form will appear 1207, and the counselor will input the information into the form 1208. The counselor may cancel out of the process at this point 1209, and he or she will be directed to the student's system page 1205. If the counselor sends the e-mail 1210, then the email is sent 1212, and the system will simultaneously create a log entry 1211, send the e-mail through the external software system, and return the counselor to the student's system page 1205. As will be apparent to those skilled in the art, other systems of facilitating communication between members at the educational institution may be established without departing from the scope of the present invention.

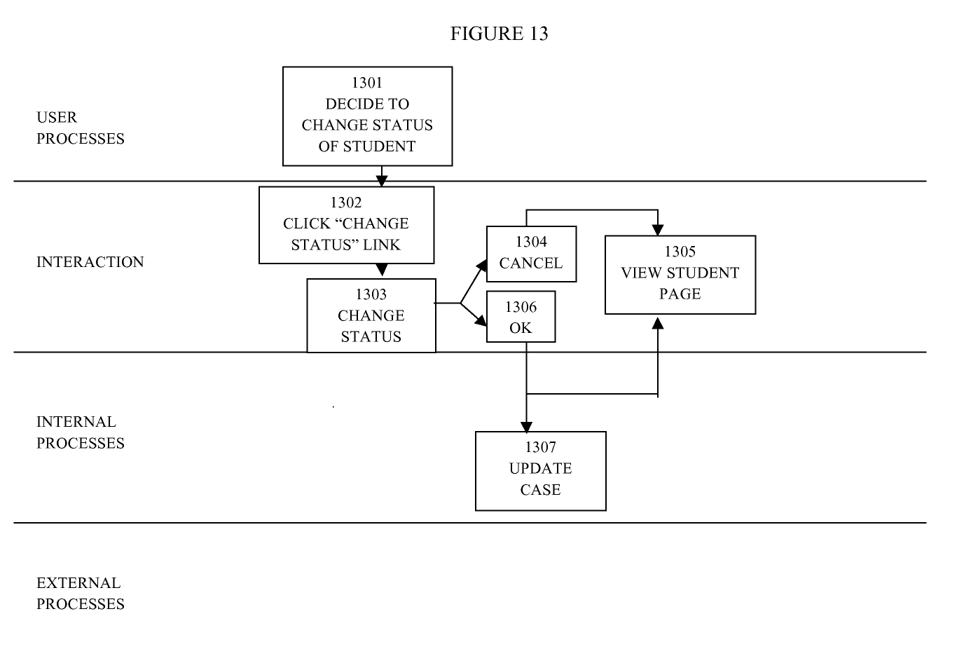

In a further embodiment, the system allows for the counselor to change the status of the student within the SOS process as illustrated in FIG. 13. Where the counselor decides to change the status of a student 1301, the counselor may click on the “change status” link within the system 1302. The change status form 1303 will appear on the screen. At this time the counselor may cancel 1304 out of the process, and be returned to the student's system page 1305. Alternatively, the counselor may continue with the process 1306, and update the case record 1307 by deciding what new status the student is to receive. If the counselor continues with the process, the case record is updated 1307, and the counselor is returned to the student's system page 1305.

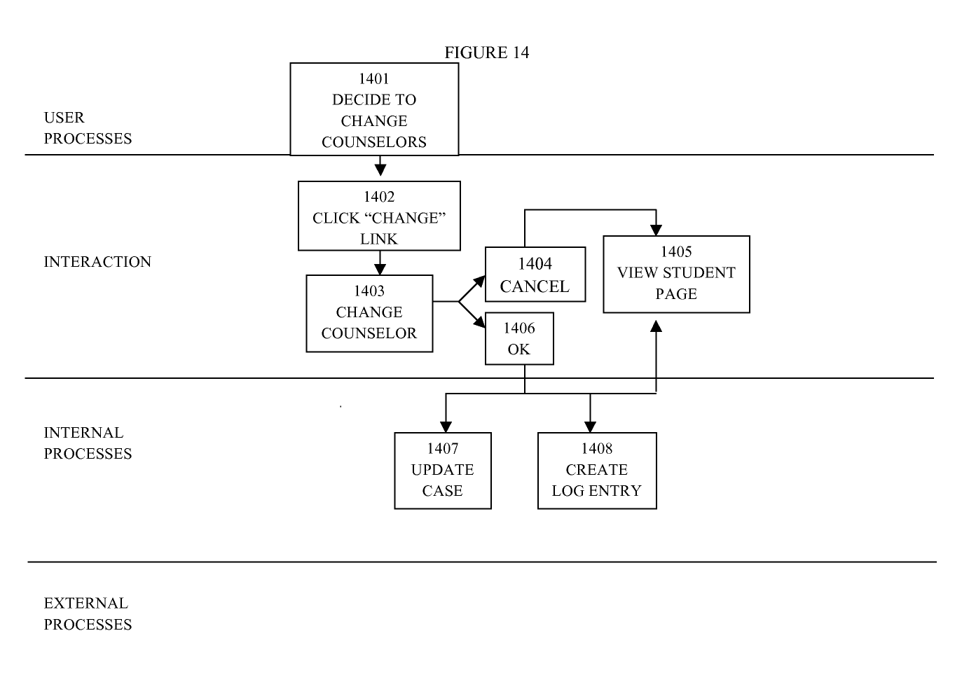

In another embodiment the present invention allows a counselor to change the student to a different counselor as illustrated in FIG. 14. Where the counselor decides to transition the student to another counselor 1401, the counselor may click on the “change” link within the system 1402. The change counselor form will then appear on the screen 1403. At this time the counselor may cancel out of the process 1404 and be returned to the student's system page 1405. If the counselor decides to change the counselor by choosing a new person, he or she will complete the form, and submit it 1406. A log entry will be created 1408, and the case record will be updated 1407 and the counselor will be returned to the student's page 1405.

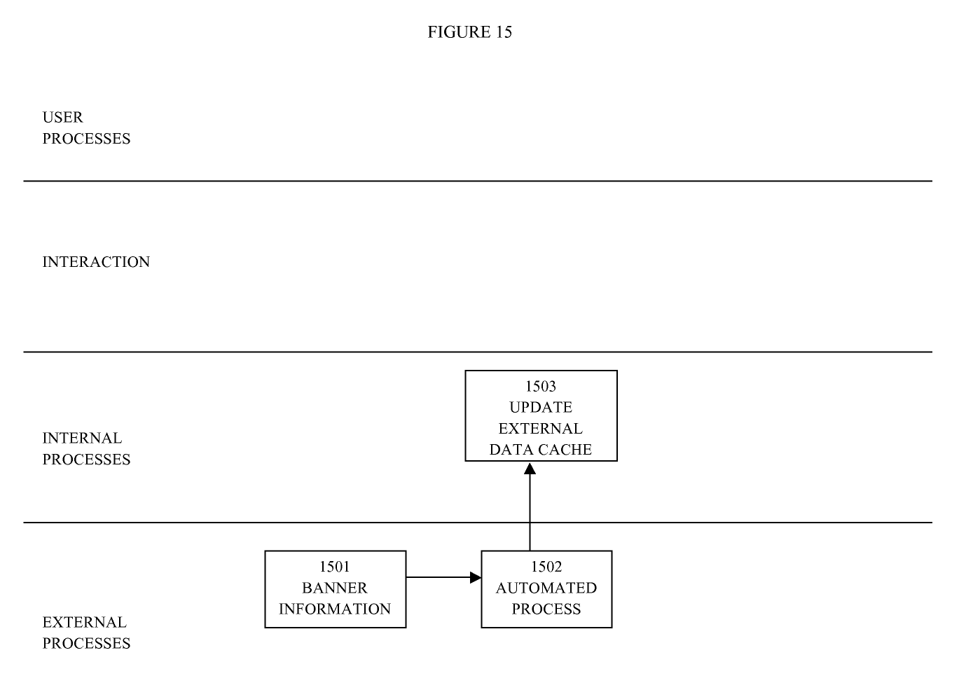

In order to give each member of the system the most up-to-date picture of the student's needs, a nightly update may be accomplished in one embodiment. As illustrated in FIG. 15, the external software updates the database 1501 & 1502, with new student information 1503 on a nightly basis.

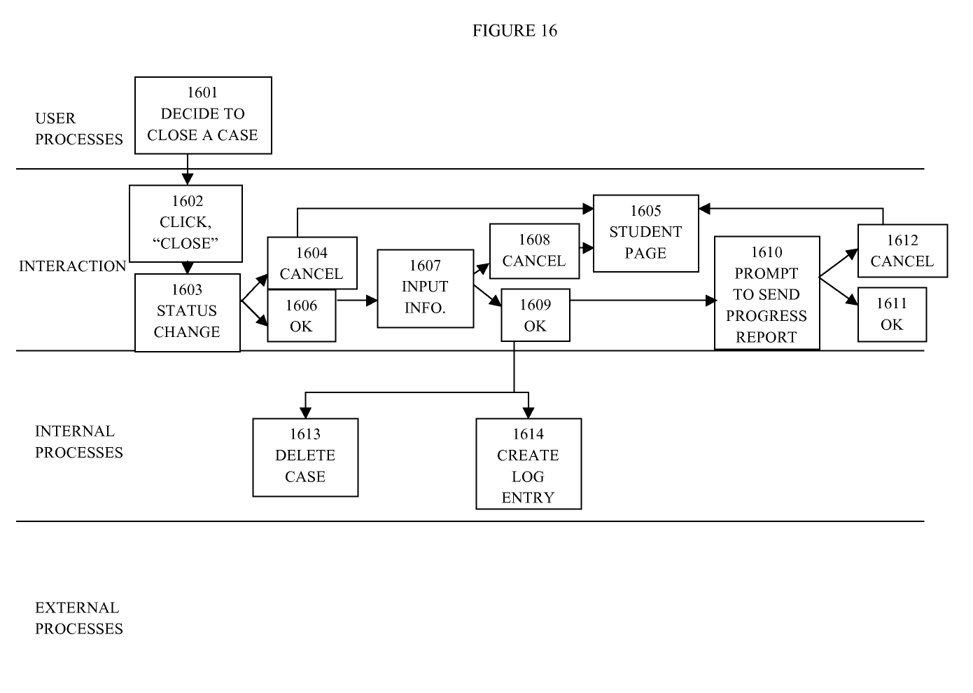

FIG. 16 illustrates an embodiment of the present invention where it is used in the closing of a student's case upon resolution. Where the counselor determines that the case should be closed 1601, the counselor may click on the “close” link within the system 1602. A change status form 1603 will appear on the screen. If the counselor cancels out of this process 1604 he or she will be returned to the student's system page 1605. If the counselor continues, 1606 the counselor will input information 1607 regarding the case closure. The counselor again may cancel out the process 1608 and be returned to the student's page 1605. If the counselor progresses 1609, a log entry is created 1614, the case record is deleted 1613 from the system simultaneously. The counselor is also given a prompt to send a progress report is sent to the counselor 1610. The counselor may then proceed with the progress report 1611, or cancel out of the process 1612 and be returned to the student's page 1605. In one embodiment, the marking of a student's file in the system “resolved” does not delete the file from the system in its entirety. The counselor's case notes will remain. Therefore, if the student is again referred to the system for another need or at another time, the previous file of case notes exists for the next counselor to incorporate into his or her review and assessment of the new situation.

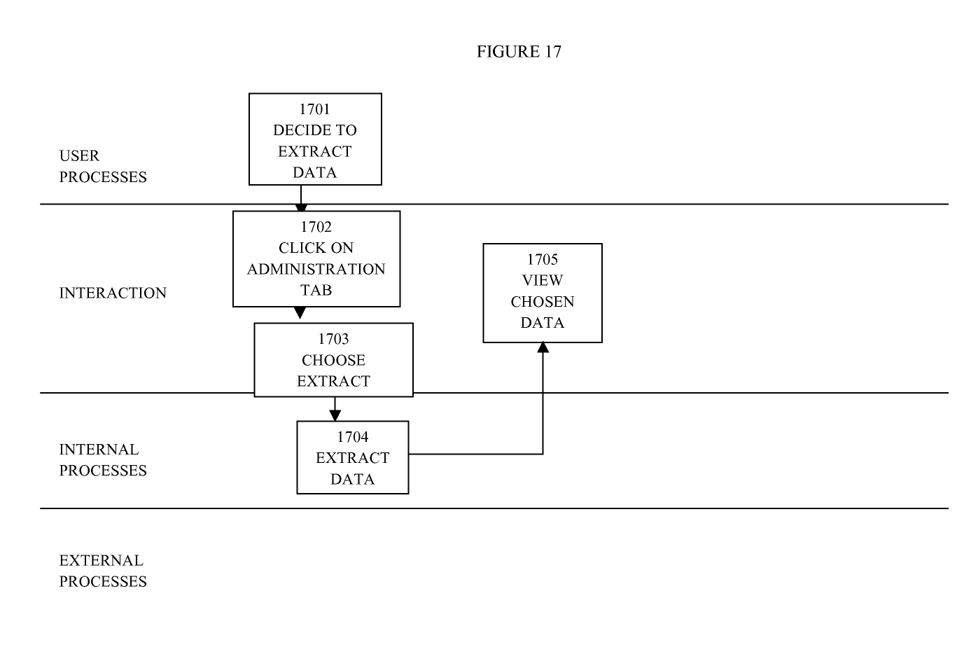

In another embodiment of the present invention, an authorized member of the educational institution may use the present invention to access various metrics of the system as illustrated in FIG. 17. The authorized member first logs into the system. Once authenticated, the member decides to extract data from the system 1701. The member may then access metrics by clicking on the “administration” tab 1702. Various metrics may be accessed, and the authorized member may choose the data he or she is interested in 1703. The data is extracted 1704, and the authorized member is able to view the data chosen 1705. Charts or graphs may be easily generated from the metrics chosen through the system. Metrics that are available include but are not limited to: efficacy of specific counselors, frequency of specific issues being brought to the system, resolution frequency, affect of resolution on retention rates, affect of being in the SOS system on retention rates, and the direct impact of the system addressing student needs on retention rates at the educational institution as a whole.

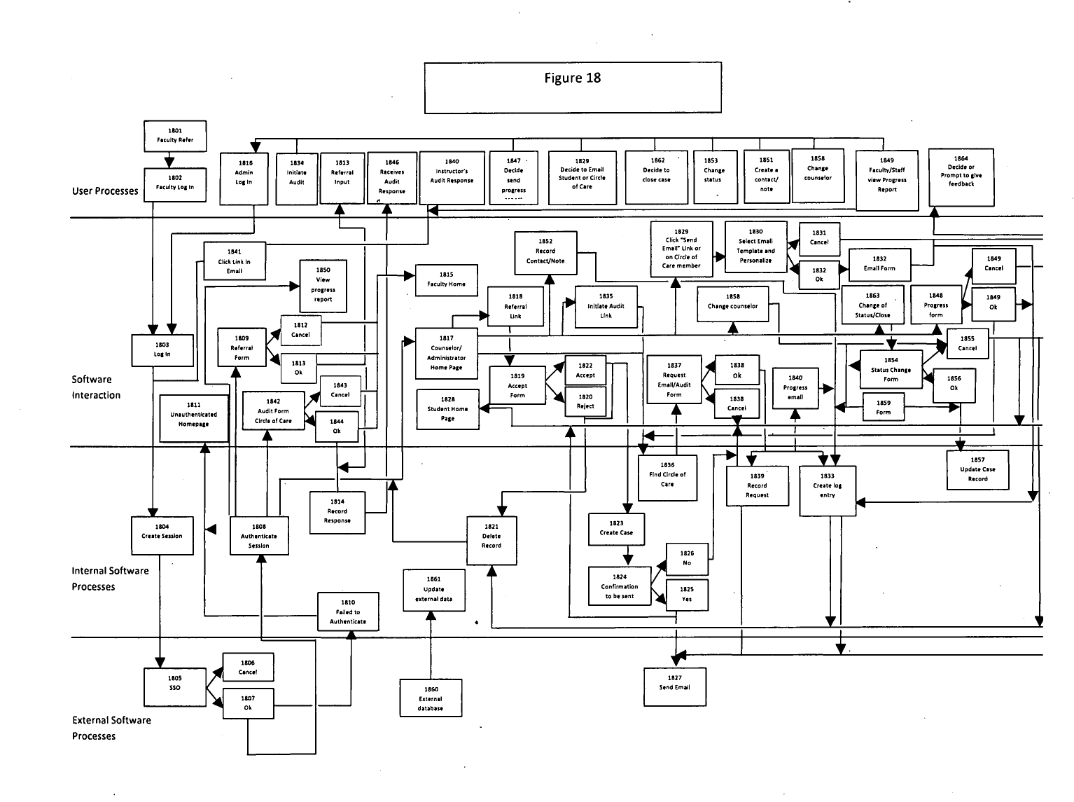

For comprehensiveness, FIG. 18 is provided and illustrates how each part of the system interacts to accomplish effective case or client management.

### WORKING EXAMPLES

### Example 1

Professor notices Student has not attended class for one week. Professor accesses the system from his computer at the educational institution and indicates that he would like to make a referral by opening a link to the referral page FIG. 2. He then fills out a referral of Student FIG. 2. Professor indicates Student's name and identification number, Professor's name and department, as well as his telephone number FIG. 2. Professor then checks a box on the interface stating that he is concerned with Student's attendance FIG. 3. Professor also indicates that he has e-mailed the student inquiring about his absence. Professor additionally indicates in the box provided that he is concerned that the student has been absent from class for one week, and did not return his e-mail. The Professor then submits the referral to the institution, by pressing a button on the referral page FIG. 2.

The referral is received by the SOS program coordinator FIG. 5. Because Professor sent the referral via the network system, the coordinator receives the referral in the program's inbox. The coordinator logs into the program's inbox FIG. 4, reviews the referral, finds that the subject matter is appropriate for assistance, and accepts the student into the system FIG. 5.

Upon acceptance, an e-mail is sent to Professor indicating that he will be to be notified as Student progresses through the system, and provides a link for Professor to use so that he may monitor Student's progress when appropriate FIG. 5. The Professor is now in Student's Circle of Care network. Student, now accepted into the system, has a file automatically created using the present invention and in communication with software already employed by the educational institution that contains his information such as his course schedule, name, identification number, parent information, and telephone number FIG. 5. Student's SOS system file is assigned to Counselor FIG. 5.

Counselor, receiving Student's e-mail address in the file, e-mails him to identify what the issue is that is preventing him from attending Professor's class FIG. 6. Student returns the e-mail and tells Counselor that he was diagnosed with mono and is having a friend take notes for him while he recovers. Student explains that he expects to resume attending the class next week. Counselor encourages Student to contact Professor by whatever means is convenient, and to contact any other instructors in which Student is not attending class. Counselor asks the student to notify her when he has contacted his instructors and resumes attendance.

Counselor then logs into the system and notes that she had a telephone conversation with Student, that his attendance will resume quickly and that he has not missed the information given at class, and that he will contact his instructors regarding his absence FIG. 11. Counselor also initiates an audit of student's other current instructors by logging on to the system, allowing the system to retrieve such information, and sending a link to the instructors requesting information from them FIG. 7. The student's instructors respond, many stating that student has been absent from class FIG. 8. Counselor then sends an e-mail to Professor and student's other instructors indicating that a Progress Report has been added to the student's file FIG. 9. When instructor receives this e-mail, he may click on the link provided and view the Progress Report which indicates that student is receiving class notes from a friend, will resume class attendance next week, and that Student will contact Professor, and his other instructors regarding his absence FIG. 10. When Student e-mails Counselor the next week stating that he has resumed attending class and has contacted all of his instructors regarding his absence, Counselor marks his file “resolved” FIG. 16.

A system that provides means for members of the educational institution to efficiently interact, transmit, and gather information to proactively identify and assist a student in need has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A software system that facilitates the identification and assistance of a student in need by connecting members with access to the software system and other individuals with a relationship to the student in need, wherein data compiled and dispersed within the software system results in a determination by a coordinator of whether assistance is needed by the student in need and, if such assistance is needed by the student in need the software system facilitates a course of action to address the student in need's need, comprising:
computer processor means for processing data relating to the student in need;
storage means for storing data relating to the student in need on a storage medium;
first means for identifying and authenticating one of said members or the coordinator to use the software system wherein one of said members or the coordinator is directed to a page customized for said member's or coordinator's use;
second means for one of said members or the coordinator to view and input data relating to the student in need on the storage medium;
third means for another of said members to view the input data relating to the student in need on the storage medium and to input data relating to the student in need on the storage medium;
fourth means for one of said members or the coordinator to send data relating to the student in need on the storage medium to another of said members or one of said individuals with a relationship to the student in need; and
fifth means for one of said members or the coordinator to send a request for data relating to the student in need to at least one other of said members or said individuals with a relationship to the student in need.

2. The software system of claim 1, wherein a web application provides an interface for one of said members to view, input, and disperse data relating to the student in need that may be accessed and viewed by another of said members having access to the software system or communicated to one of said individuals with a relationship to the student in need.

3. The software system of claim 1, wherein the storage medium collects data regarding a plurality of students in need, such as whether the student in need was identified as needing assistance, whether assistance was rendered, the frequency with which a need is found, the outcome for the student in need after assistance is rendered, retention of a plurality of students in need, and the efficacy of a counselor assisting the student in need where said data may be accessed by one of said members or the coordinator having access to the software system.

4. The software system of claim 1, wherein the need of the student in need is academic, physical, mental, career, major area of study, personal, religious or financial.

5. The software system of claim 1, wherein once one of said members utilizes the software system to identify the student in need, a system file is created for the student in need, wherein the system file provides a centralized location to view, input and store data relating to the student in need and said system file remains on the storage medium after assistance has been rendered to the student in need.

6. The software system of claim 1, wherein the student in need is assisted through the steps comprising:
one of said members submitting data through the storage medium to the coordinator to identify the student in need;
the coordinator determining that the student in need has a need that may be addressed with assistance from the software system and assigning a counselor to the student in need and indicating the assignment on the storage medium, wherein the selection of the counselor may change during the identification and assistance of the student in need and where the counselor may access a system file created for the student in need that contains data relating to the student in need and wherein the counselor may input data regarding progress of assistance to the student in need;
the counselor submitting a request for data relating to the student in need to at least one of said members through the software system;
at least one of said members utilizing the software system to input data relating to the student in need on the storage medium;
the counselor reviewing data relating to the student in need and determining what type of assistance should be rendered;
at least one of said members or at least one of said other individuals with a relationship to the student in need gathering, inputting, viewing, or receiving data relating to the student in need through use of the software system; and
inputting data by the counselor or the coordinator relating to assistance rendered to the student in need; and the outcome of the assistance rendered to the student in need.

7. The software system of claim 6, wherein the storage medium may gather and transmit data relating to the student in need as the data is input by one of said members or the coordinator, and said storage medium containing additional information relating to the student in need that exists as part of the administrative process for registration within an educational institution that may be accessed and viewed by one of said members or the coordinator.

8. The software system of claim 6, wherein one of said members, a counselor, or the coordinator may initiate an audit of the student in need to gather data relating to the student in need from at least one other of said members.

9. The software system of claim 6, wherein members who input data onto the storage medium relating to the student in need may be contacted through use of the software system by one of said plurality of members or the coordinator with information regarding the student in need.

10. The software system of claim 6, wherein the storage medium containing data relating to the student in need is updated daily to reflect data input relating to the student in need by any of said members or the coordinator.

11. An educational institution software system that facilitates the identification and assistance of a student with an academic, physical, mental, career, major area of study, personal, religious, or financial need by connecting a plurality of members of the educational institution and may also connect other individuals with a relationship to the student, wherein the data compiled by said plurality of members and said individuals and shared with said plurality of members and said individuals by the software system allows a coordinator within the educational institution to determine if the student's need should be addressed, and if the student's need should be addressed, the software system facilitates a course of action to render the student with assistance, comprising:
computer processor means for processing data relating to the student;
storage means for storing data relating to the student on a storage medium;
a plurality of software pages to indicate need, provide assistance, provide and collect information relating to the student, and provide means for communication with said plurality of members and said plurality of individuals with a relationship to the student;
first means for identifying and authenticating one of said members or the coordinator to use the software system wherein one of said members or the coordinator is directed to a page customized for said member's or coordinator's use;
second means for one of said members or the coordinator to view and input data relating to the student on the storage medium;
third means for another of said members to view the input data relating to the student on the storage medium and to input data on the storage medium;
fourth means for one of said members or the coordinator to send data relating to the student on the storage medium to another of said members or one of said individuals with a relationship to the student; and
fifth means for one of said members or the coordinator to send a request for data relating to the student to other said members or said individuals with a relationship to the student.

12. The software system of claim 11, wherein a web application provides an interface for one of said members to view, input, and disperse data relating to the student that may be accessed and viewed by another of said members having access to the software system or communicated to one of said individuals with a relationship to the student.

13. The software system of claim 11, wherein the storage medium collects data regarding a plurality of students, such as whether the student was identified as needing assistance, whether assistance was rendered to the student, the frequency with which a need is found, the outcome for the student after assistance is rendered, retention of a plurality of students, and the efficacy of a counselor assisting the student where said data may be accessed by one of said members or the coordinator having access to the software system.

14. The software system of claim 11, wherein once one of said members utilizes the software system to identify the student, a system file is created for the student, wherein the system file provides a centralized location to view, input and store data relating to the student and said system file remains on the storage medium after assistance has been rendered to the student.

15. The software system of claim 11, wherein the student is assisted through the steps comprising:
one of said members submitting data through the storage medium to the coordinator to identify the student;
the coordinator determining that the student has a need that may be addressed with assistance from the software system and assigning a counselor to the student and indicating the assignment on the storage medium, wherein the selection of the counselor may change during the identification and assistance of the student and where the counselor may access a system file created for the student that contains data relating to the student and wherein the counselor may input data regarding progress of assistance to the student;
the counselor submitting a request for data relating to the student to at least one of said members through the software system;
at least one of said members utilizing the software system to input data relating to the student on the storage medium;
the counselor reviewing data relating to the student and determining what type of assistance should be rendered;
at least one of said members or at least one of said other individuals with a relationship to the student gathering, inputting, viewing, or receiving data relating to the student through use of the software system; and
inputting data by the counselor or coordinator relating to assistance rendered to the student, and the outcome of the assistance rendered to the student.

16. The software system of claim 11, wherein the storage medium may gather and transmit data relating to the student as it is input by one of said members, and said storage medium containing additional information relating to the student that exists as part of the administrative process for registration within the educational institution that may be accessed and viewed by one of said members or the coordinator.

17. The software system of claim 11, wherein one of said members or the coordinator may initiate an audit of the student to gather data relating to the student from at least one other of said members.

18. The software system of claim 11, wherein members who input data onto the storage medium relating to the student may be contacted through use of the software system by one of said plurality of members or the coordinator with information regarding the student.

19. The software system of claim 11, wherein the storage medium containing data relating to the student is updated daily to reflect data input relating to the student by at least one of said members or the coordinator.

20. An apparatus for identifying and assisting a student in need, comprising:
a database that may store information relating to the student in need;
a software system that can be implemented on a computer processor, comprising:
first means for identifying and authenticating one of a plurality of members or a coordinator authorized to use the software system wherein one of said members or the coordinator is directed to a page customized for said member's or coordinator's use;
second means for one of said members or the coordinator to view and input data relating to the student in need onto a storage medium;
third means for another of said members to view the input data relating to the student in need on the storage medium and to input additional data on the storage medium;
fourth means for one of said members or the coordinator to send data relating to the student in need on the storage medium to another of said members or one of a plurality of individuals with a relationship to the student in need; and
fifth means for one of said members or the coordinator to send a request for data relating to the student in need to at least one other of said members or said individuals with a relationship to the student in need.

21. The apparatus for identifying and assisting a student in need of claim 20, wherein the software system is a web based application.

22. An apparatus for identifying and assisting a student in need comprising;
a software system that facilitates the identification and assistance of a student with an academic, physical, mental, career, major area of study, personal, religious, or financial need by connecting a plurality of members of the educational institution and may also connect other individuals with a relationship to the student in need, wherein the data compiled and shared by utilizing the software system allows the coordinator at the educational institution to determine if the student's need should be addressed, and if the student in need's need should be addressed, the software system can facilitate course of action to render the student in need with assistance, that can be implemented on a computer processor comprising:
a database for storage of data relating to the student in need;
a plurality of software pages that interface with the database to indicate need, provide assistance, provide and collect information relating to the student in need, and provide means for communication with other members or individuals with a relationship to the student in need;
first means for identifying and authenticating one of said members or the coordinator to use the software system wherein one of said members or the coordinator is directed to a page customized for said member's or coordinator's use;
second means for one of said members or the coordinator to view and input data relating to the student in need onto the database;
third means for another of said members to view the input data relating to the student in need onto the database and to input data onto the database;
fourth means for one of said members or the coordinator to send data relating to the student in need on the database to another of said members or one of said individuals with a relationship to the student in need; and
fifth means for one of said members or the coordinator to send a request for data relating to the student in need to other said members or said individuals with a relationship to the student in need.

23. The apparatus of claim 22, wherein the software system is a web based application.

24. The apparatus of claim 22, wherein the plurality of software pages contain templates for use by the members of the educational institution to communicate with other members, the student in need, or other persons with a relationship to the student in need.
